(19) United States
(12) Patent Application Publication
(10) Pub. No.: US 2011/0045283 A1
(43) Pub. Date: Feb. 24, 2011

(54) ABRASION-BLASTED CUTTING INSERT AND METHOD

(75) Inventors: Helga Holzschuh, Mehrstetten (DE); Jörg Drobniewski, Herrenberg (DE)

Correspondence Address: DRINKER BIDDLE & REATH (DC), 1500 K STREET, N.W., SUITE 1100, WASHINGTON, DC, 20005-1209, US

(73) Assignee: Walter AG, Tubingen (DE)

(21) Appl. No.: 12/867,662

(22) PCT Filed: Feb. 5, 2009
(86) PCT No.: PCT/EP09/51316

§ 371 Date: Nov. 9, 2010

(30) Foreign Application Priority Data
Feb. 15, 2008 (DE) 10 2008 009 487.0

(51) Int. Cl. B05D 3/12; B32B 15/04; B32B 18/00

(52) U.S. Cl. 428/336; 427/289

(57) ABSTRACT

The invention relates to a cutting insert and a method for its production, in which a hard-metal, cermet, or ceramic substrate body is coated by means of a PVD, PCVD or CVD method with a single- or multi-layer coating of carbides, nitrides, oxides, carbonitrides, oxinitrides, oxicarbides, oxicarbonitrides, borides, boron nitrides, boron carbides, boron carbonitrides, boron oxinitrides, boron oxocarbides, boron oxocarbonitrides of the elements of groups IVa to VIIa of the periodic table and/or of aluminium and/or mixed-metal phases and/or phase mixtures of the above-named compounds and, after the coating, the substrate body is subjected to dry or wet abrasion blasting using a granular blasting abrasive. In order to provide a cutting insert with improved wear resistance and improved cutting properties, in particular improved ridge-type crack resistance and/or tensile capacity, according to the invention the hardness of the abrasive is lower than the hardness of the outermost layer of the coating or the hardness of the abrasive is higher than the hardness of the outermost layer of the coating and a layer the hardness of which is higher than the hardness of the abrasive is arranged below the outermost sheet, wherein at least portions of the layer(s) arranged above the layer the hardness of which is higher than the hardness of the abrasive are abraded by the abrasion blasting, the total layer thickness of the coating is at most 40 μm, the abrasion blasting takes place at a blasting pressure of 1 bar to 10 bar and is carried out for a period which is sufficient for 10 MPa<Δ S_{BES}<1000 MPa and [Δ S_{BES}/Δ S_{SUB}]<2, wherein Δ S_{BES} is the value of the greatest change in residual stress in the coating after the abrasion blasting compared with the non-abrasion-blasted cutting insert and Δ S_{SUB} is the value of the greatest change in residual stress in the substrate after the abrasion blasting compared with the non-abrasion-blasted cutting insert in a region of the substrate surface to a penetration depth of 10 μm.

The invention relates to methods for the production of cutting inserts and the cutting inserts which can be produced according to the methods.

Cutting inserts consist of a hard-metal, cermet, or ceramic substrate body which in most cases is provided with a single- or multi-layer surface coating to improve the cutting and/or wear properties. The surface coatings consist of sheets or layers of hard material, arranged one above the other, of carbides, nitrides, oxides, carbonitrides, oxinitrides, oxicarbides, oxicarbonitrides, borides, boron nitrides, boron carbides, boron carbonitrides, boron oxinitrides, boron oxocarbides and boron oxocarbonitrides of the elements of groups IVa to VIIa of the periodic table and/or of aluminium, mixed-metal phases and phase mixtures of the above-named compounds. Examples of the above-named compounds are TiN, TiC, TiCN and Al₂O₃. An example of a mixed-metal phase in which one metal is partly replaced by another in a crystal is TiAlN. The coating is applied by CVD methods (chemical vapour deposition), PCVD methods (plasma-supported CVD methods) or by PVD methods (physical vapour deposition) methods.

Nearly every material has internal residual stresses as a result of mechanical, thermal and/or chemical treatment. During the production of cutting inserts by coating a substrate body by means of CVD methods, residual stresses result for example between the coating and the substrate and between the individual layers of the coating from the different coefficients of thermal expansion of the materials. The residual stresses can be residual tensile stresses or residual compressive stresses. When applying a coating by means of PVD methods, additional stresses are introduced into the coating by ion bombardment during this method. In coatings applied by means of PVD methods, residual compressive stresses generally predominate, whereas CVD methods usually produce residual tensile stresses in the coating.

The action of the residual stresses in the coating and in the substrate body may not have a significant effect on the properties of the cutting insert, but may also have substantial advantageous or disadvantageous effects on the wear resistance of the cutting insert. Residual tensile stresses which exceed the yield stress of the respective material cause fractures and cracks in the coating perpendicular to the direction of the residual tensile stress. Generally, a degree of residual compressive stress is desired in the coating, as surface cracks are thereby prevented or closed and the fatigue properties of the coating and thus of the cutting insert are improved. Too high residual compressive stresses can, however, lead to adhesion problems and spalling of the coating.

There are 3 types of residual stresses: macrostresses, which are distributed virtually homogeneously over macroscopic regions of the material; microstresses, which are homogeneous in microscopic regions such as for example a grain; and non-homogeneous microstresses, which are non-homogeneous also on a microscopic level. The macrostresses are of particular importance from a practical point of view and for the mechanical properties of a cutting insert.

It is known that hard-metal cutting tools which are coated with layers of hard material such as for example TiN, TiC, TiCN, TiAlN, Al₂O₃ or combinations thereof, can display outstanding wear resistance, but may more likely fail in continuous cutting operations due to a loss of toughness compared with uncoated cutting tools or tools coated by means of PVD methods.

DE 197 19 195 describes a cutting insert with a multi-layer coating which is deposited in a continuous CVD method at temperatures between 900° C. and 1,100° C. The change of material in the multi-layer coating from one layer to the next takes place by changing the gas composition in the CVD method. The outermost layer (cover layer) consists of a single- or multi-phase layer of carbides, nitrides or carbonitrides of Zr or Hf, in which internal residual compressive stresses predominate. The layers below consist of TiN, TiC or TiCN and without exception display internal residual tensile stresses. The residual compressive stress measured in the outermost layer lies between −500 and −2,500 MPa. The fracture toughness is to be thereby improved.

To increase the residual compressive stresses in the coating of the substrate body of cutting inserts or other tools it is known to subject these to a mechanical surface treatment. Known mechanical treatment methods are brushing and abrasion blasting. In the case of abrasion blasting a fine-grained blasting abrasive with particle sizes of up to approximately 600 μm is directed onto the surface of the coating by means of compressed air at increased pressure. Such a surface treatment can reduce residual tensile stresses or increase residual compressive stresses in the outermost layer and also in the layers below. In the case of abrasion blasting a distinction is drawn between dry abrasion blasting, in which the fine-grained blasting abrasive is used dry, and wet abrasion blasting, in which the granular blasting abrasive is present suspended in a liquid.

It was found that the selection of the abrasive has a significant effect on the changes in the residual stresses in the coating and in the substrate of the cutting insert, in particular the hardness of the abrasive in relation to the hardness and thickness of the coating. It was able to be shown that, when using an abrasive the hardness of which is higher than the hardness of the outermost layer of the coating, the wear mechanism is abrasion and high compressive stresses appear only on the near surface regions of the layer to a penetration depth of approx. 1 μm, and these relax again very quickly. In deeper layers or in the substrate, there is essentially no reduction in the tensile stresses or increase in the compressive stresses. The residual stress predominating in the substrate after the coating process remains unchanged. An increase in the toughness of the tool cannot be achieved.

If the hardness of the abrasive is equal to the hardness of the outermost layer of the coating, the wear mechanism is surface breakdown and high compressive stresses form which can have effect into the deeper coating layers and, depending on the coating thickness, even into the substrate. In thick layers (>>10 μm), the stress in the substrate can be changed only a little and the tensile capacity increased during wet-blasting. If it is nevertheless desired to also increase the compressive stress in the substrate with thick layers, prolonged dry abrasion blasting is necessary, which leads to an increase in imperfections in the lattice and can cause adhesion problems during coating.

The object of the present inventions was the provision of a method for the production of a cutting insert and a cutting insert which can be produced according to the method with increased residual compressive stresses in the substrate body and with improved wear resistance and improved cutting properties, in particular improved ridge-type crack resistance and/or tensile capacity.

This object is achieved by a method for the production of a cutting insert, in which a hard-metal, cermet, or ceramic substrate body is coated by means of a PVD, PCVD or CVD method with a single- or multi-layer coating of carbides, nitrides, oxides, carbonitrides, oxinitrides, oxicarbides, oxicarbonitrides, borides, boron nitrides, boron carbides, boron carbonitrides, boron oxinitrides, boron oxocarbides, boron oxocarbonitrides of the elements of groups IVa to VIIa of the periodic table and/or of aluminium and/or mixed-metal phases and/or phase mixtures of the above-named compounds and, after the coating, the substrate body is subjected to dry or wet abrasion blasting using a granular blasting abrasive, wherein
the hardness of the abrasive is lower than the hardness of the outermost layer of the coating or
the hardness of the abrasive is higher than the hardness of the outermost layer of the coating and arranged below the outermost layer is a layer the hardness of which is higher than the hardness of the abrasive, wherein at least portions of the layer(s) arranged above the layer the hardness of which is higher than the hardness of the abrasive are abraded by the abrasion blasting,
   the total layer thickness of the coating is at most 40 μm,
   the abrasion blasting takes place at a blasting pressure of 1 bar to 10 bar and is carried out for a period which is sufficient for

10 MPa<ΔS_{BES}<1000 MPa and [ΔS_{BES}/ΔS_{SUB}]<2,
wherein Δ S_{BES} is the value of the greatest change in the residual stress in the coating after abrasion blasting compared with the non-abrasion-blasted cutting insert and Δ S_{SUB} is the value of the greatest change in residual stress in the substrate after the abrasion blasting compared with the non-abrasion-blasted cutting insert in an area of the substrate surface to a penetration depth of 10 μm.

It was surprisingly found that particularly high residual compressive stresses can be created in a coated cutting insert by post-treatment by means of blasting with an abrasive, preferably by dry abrasion blasting, in the near-surface regions and the so-called “near-interface substrate zone” of the substrate body, even when the single- or multi-layer coating has a total layer thickness of up to 40 μm, the abrasion blasting is carried out at a blasting pressure of 1 bar to 10 bar and the hardness of the abrasive is lower than the hardness of the outermost layer (cover layer). One advantage of the method according to the invention is that no, or only very small, degrees of disruption are introduced into the uppermost layers of the coating. The uppermost layer and the further layers of the coating show only a small change in their residual stresses.

The term “near-surface region” of the substrate body denotes a region of the outermost surface of the substrate body to a penetration depth of at most 1 to 2 μm in the direction of the inside of the substrate body. The non-destructive and phase-selective analysis of residual stresses takes place by means of X-ray diffraction methods. The widely-used angle-dispersive measurement according to the sin² ψ method delivers a mean value for the residual stress portion in a plane and allows residual stress measurements in WC substrates only to very small penetration depths of at most 1 to 2 μm from the surface, i.e. only in the “near-surface region” of the substrate body. [cf. also “measurement methods” below]

The term “near-interface substrate zone” of the substrate body denotes a region of the outermost surface of the substrate body to a penetration depth of at most 10 μm in the direction of the inside of the substrate body. Analyses of the pattern of the residual stresses in the “near-interface substrate zone” were not possible with the previously used angle-dispersive measurement methods with conventional laboratory sources. Firstly, the penetration depth of the angle-dispersive measurement is, as mentioned above, limited to only a very short distance from the outermost surface of the substrate body. In addition, the angle-dispersive measurement according to the sin² ψ method delivers only one mean value in one plane, which is why stepwise changes or courses of gradients of the residual stresses within short distances cannot be measured with this method. To analyze the residual stresses in the “near-interface substrate zone” of the substrate body to a penetration depth of approximately 10 μm, the inventors therefore for the first time used an energy-dispersive measurement for the cutting inserts according to the preamble which permits the analysis of residual stress patterns to a penetration depth of approximately 10 μm, recording the change in residual stresses within this region. [cf. also “measurement methods” below]

The parameter “Δ S_{BES}” denotes the value of the greatest change in residual stresses in the coating, and “Δ S_{SUB}” denotes the level of the greatest change in residual stresses in the substrate, i.e. the difference in the respective residual stresses between an untreated sample and a sample after abrasion blasting. The term “greatest” change in residual stress means that the difference in residual stresses in the regions of the coating or of the substrate is measured where this difference is at its greatest.

A further parameter for characterizing the cutting inserts produced according to the invention is the “integral width” in the X-ray diffraction pattern. Interference band profiles whose shape depends on the structure of the material examined are measured by means of diffractometric diffraction methods. The interference band profile is described by giving its position, intensity and bandwidth. The position of the interference bands is characteristic of the crystal structure of the material and serves to identify the (crystalline) material phases, while the macroscopic lattice strains and material-inherent residual stresses can be calculated from the shifts. Quantitative phase contents and the crystallographic texture of the material are ascertained from the integral intensities of the bands, given by the area under the diffraction profile. The so-called “integral width” is a measure used to describe the dispersion of the diffraction profile. It is calculated from the quotient of integral intensity and the intensity in the maximum of the band. Clearly, the integral intensity is thus equal to the length of the sides of a rectangle which has the same area as the integral under the diffraction curve and whose other side is equal to the maximum intensity of the profile (M. v. Laue, Z. Kristallographie 64 (1926), 1 15). Compared with the often-used half-width of the diffraction profile, i.e. the width of the diffraction band at half the maximum intensity, which represents an arbitrary measure for describing the dispersion, the integral width contains information about the microstructure of the structure of the material, described by the size of the coherently-scattering regions (particle size) and the microstrains, i.e. the structure of defects in the lattice. A large number of profile-analyzing approaches exist in the literature for ascertaining domain sizes and microstrains from the integral widths of individual diffraction bands or entire diffraction spectra (see for example E. J. Mittemeijer, P. Scardi (Eds.), Diffraction Analysis of the Microstructure of Materials. Springer Series in Materials Science, Volume 68, 2004). The source of the integral widths ascertained in the present examinations on the non-blasted and blasted layers and observed band broadenings is to be found in the increase in the degree of lattice imperfection as a result of the abrasion blasting. The integral widths of a non-abrasion-blasted Al₂O₃ layer are usually of the order of 0.1 or less. In the case of abrasion blasting with an abrasive the hardness of which is equal to the hardness of the blasted Al₂O₃ layer, e.g. Al₂O₃ as blasting abrasive, the integral width increases to values of 0.3 to 0.7 due to the contribution of lattice imperfections. When using an abrasive the hardness of which is lower than the hardness of the Al₂O₃ layer, as in the method according to the invention, there is no measurable change in the integral width.

The coating consists preferably of a succession of different single layers. Because of their varying compositions, production conditions and positions within the coating, these different layers generally already also possess different residual stresses, i.e. tensile or compressive stresses of different sizes, before the abrasion blasting. Because of the abrasion blasting the residual stresses in the individual layers again change to varying degrees because of their different compositions, production conditions and positions within the coating. Where this change is at its greatest within the total coating, the value “Δ S_{BES}” is measured or the condition according to the claim must be met. The same applies also for the substrate, where the residual stresses and changes in residual stresses at different depths from the surface can also vary in size. The conditions for “Δ S_{SUB}” are, by definition, limited to a region of the substrate surface to a penetration depth of 10 μm, because a measurement of the residual stresses at much greater depths is not technically possible in WC substrates.

In a preferred embodiment of the invention the outermost layer of the total coating consists of Al₂O₃ or TiN. Any material known in the field is suitable as blasting abrasive if its hardness is lower than that of the layer which is to remain as outermost layer after the abrasion blasting. Particularly preferably the abrasive has a hardness which is lower than the hardness of the outermost layer before the abrasion blasting. In this case the abrasion blasting does not have an abrasive effect, and what was the outermost layer before the abrasion blasting also remains the outermost layer after the abrasion blasting.

In the method according to the invention it is not essential that the layer the hardness of which is higher than the hardness of the abrasive is already the outermost layer of the multi-layer coating on the substrate body even before the abrasion blasting. In the PVD, PCVD or CVD method used for the production of the coating on the substrate body at least one further layer can be provided the hardness of which is lower than the hardness of the abrasive, over the layer the hardness of which is higher than the hardness of the abrasive. In the abrasion blasting method, the abrasive then has an abrasive effect as regards this (these) further layer (layers), and abrades the latter to the layer the hardness of which is higher than the hardness of the abrasive. After the abrasion blasting the outermost layer is then one having a higher hardness than the hardness of the abrasive.

If, before the abrasion blasting of the coated substrate body at least one further (softer) layer the hardness of which is lower than the hardness of the blasting abrasive is provided above the layer (e.g. an Al₂O₃ layer or a TiN layer), the hardness of which is higher than the hardness of the abrasive, then it is not essential in the method according to the invention that this (these) softer layer(s) is (are) abraded by the abrasion blasting method over the whole surface area of the substrate body. In a preferred embodiment of the invention the softer layer(s) is (are) abraded only from the surfaces of the tool particularly stressed during the operation of the tool and/or coming into contact with the workpiece, preferably only from the machined surface or the side of the tool comprising the machined surface, and these surfaces subjected to the abrasion blasting advantageous according to the invention. The changes advantageous according to the invention in the residual stresses are then effected in the particularly stressed regions.

When using an abrasive the hardness of which is lower than the hardness of the outermost layer or the layer which is to remain the outermost layer after the abrasion blasting, surface breakdown (shot peening) is essentially taken to be the wear mechanism for this outermost layer. There is no substantial abrasion such as is the case if the hardness of the abrasive is higher than the hardness of the outermost layer. It has surprisingly been shown that high residual compressive stresses can be produced in the substrate body by this mechanism and this method even if the total layer thickness of the coating is up to 40 μm. This was surprising because, with such high total layer thicknesses of the coating, it would usually be assumed that the penetration depth of the residual compressive stresses produced by the method in the substrate is too small to achieve the properties, advantageous according to the invention, of the produced cutting inserts. However, the opposite was observed. Preferably the total thickness of the coating is at most 30 μm, preferably at most 25 μm, particularly preferably at most 20 μm.

The total layer thickness of the coating should however expediently be at least 1 μm, preferably at least 5 μm, particularly preferably at least 10 μm, very particularly preferably at least 15 μm. Too small a total layer thickness of the coating has the disadvantage that adequate wear protection by the coating is no longer guaranteed.

The duration of the abrasion blasting and the blasting pressure are important parameters in the method according to the invention, wherein, compared with the blasting duration, the blasting pressure has the greater effect on the change in residual stresses in the coating and substrate body. The duration of the abrasion blasting must in no way be too small, in order that the desired changes in the residual stresses can reach as far as the substrate body and the above-named conditions for Δ S_{BES} and [Δ S_{BES}/Δ S_{SUB}] are met. The optimum duration of the abrasion blasting also depends on the installation used here, the distance between, the type and alignment of the blasting nozzles and of the movement of the blasting nozzles over the blasted tool. Suitable abrasion blasting durations according to the invention lie in the range of from 10 to 600 seconds, wherein particularly suitable abrasion blasting durations lie in the range of from 15 to 60 seconds. In particular if initially one or more outer layers are to be abraded by the abrasion blasting above the layer the hardness of which is higher than the hardness of the abrasive, a longer abrasion blasting duration is expedient or necessary.

In a preferred embodiment the blasting pressure is 2 bar to 8 bar, preferably 3 bar to 5 bar. In a particularly preferred embodiment the abrasion blasting is carried out at a blasting pressure of approximately 4 bar.

The method according to the invention can be carried out as dry abrasion blasting and as wet abrasion blasting. The dry abrasion blasting is very particularly preferred however as it guarantees a more uniform introduction of the blasting pressure into the coating and the substrate body over the whole surface area. Higher pressures over a long period are also possible by means of dry abrasion blasting without the tool becoming damaged thereby. There is the risk with wet abrasion blasting that the introduction of the blasting pressure at the edges of the tool, i.e. also at the important cutting edges, is substantially higher than on the flat surfaces, which can lead to the edges being damaged under the blasting pressure before a substantial or at least adequate introduction on the surfaces of the tool essential for cutting processes, in particular the machined surface, actually takes place. In addition, with wet abrasion blasting, the formation of a liquid film on the blasted surface substantially weakens the introduction of residual stresses compared with dry abrasion blasting under comparable blasting pressure conditions.

According to the invention, the coating of the substrate body can be single-layer or multi-layer, and consist of the most varied materials, as indicated above. In a very particularly preferred embodiment, however, the layer the hardness of which is higher than the hardness of the abrasive is a TiN layer or an Al₂O₃ layer.

The abrasive is particularly preferably steel, glass or ZrO₂. The abrasive preferably consists of spherical particles. The average particle size of the abrasive lies expediently in the range of from 20 to 450 μm, preferably 40 to 200 μm, particularly preferably 50 to 100 μm, but does not have a significant effect on the creation of residual compressive stresses in the substrate body. However, the average particle size of the abrasive does influence the surface roughness of the outermost layer of the coating. A small average particle size (fine granulation) provides a smooth surface during abrasion, whereas a high average particle size results in a rough surface. The creation of a smooth surface and thus the use of an abrasive with a small average particle size is preferable for the tools according to the invention.

The Vickers hardnesses of the above-named blasting abrasives lie approximately in the range of from 500 to 1500. Al₂O₃ (corundum) is not generally suitable as blasting abrasive according to the invention, as it has a very high hardness (approximately 2000 to 2500) and most of the coatings commonly used for tools are constructed from softer, or in the case of Al₂O₃ layers equally hard, layers. Only if the coating has an outermost layer which is harder than Al₂O₃ can Al₂O₃ also be used as blasting abrasive, which will not generally be the case.

In the method according to the invention the jet angle, i.e. the angle between the abrasive jet and the surface of the tool, has a substantial influence on the introduction of residual compressive stresses. The maximum introduction of residual compressive stresses takes place at a jet angle of 90°. Smaller jet angles, i.e. oblique blasting of the abrasive, lead to a more pronounced abrasion of the surface and smaller introduction of residual compressive stress. The greatest abrasion effect is achieved at jet angles of approximately 15° to 40°. The blasting parameters given in this description, such as blasting pressure and blasting duration, always refer to a jet angle of 90°, at which the examples described herein are also carried out. It may be necessary at smaller jet angles to choose a higher blasting pressure and/or a longer blasting duration in order to achieve an introduction of residual compressive stresses which corresponds to the introduction with a jet angle of 90°. With knowledge of the invention, however, a person skilled in the art can easily ascertain these parameters to be applied with smaller jet angles.

In a further preferred embodiment of the invention the layer the hardness of which is higher than the hardness of the abrasive has a layer thickness in the range of from 0.1 μm to 5 μm, preferably in the range of from 0.5 μm to 4 μm, particularly preferably in the range of from 1 μm to 3 μm.

In a preferred embodiment of the invention the multi-layer coating has an Al₂O₃ layer as outermost layer or an Al₂O₃ layer and above it a TiN layer as outermost layers, wherein the Al₂O₃ layer and preferably also the TiN layer have a higher hardness than the hardness of the abrasive. In a further preferred embodiment a TiCN layer is arranged below the Al₂O₃ layer. Further layers can be arranged above and/or below the TiCN layer. The provision between the TiCN layer and the layer arranged above of a bonding layer, the hardness of which is equal to the hardness of the abrasive, such as for example of the above-named Al₂O₃ layer, is expedient. The bonding layer improves the adhesion of the layers arranged above and below it and expediently has a thickness of 0.1 μm to 1 μm. A layer of TiAlCNO is very particularly suitable as bonding layer between a TiCN layer and an Al₂O₃ layer arranged above it, as this produces a preferred (001) fibre texture in the α-Al₂O₃ layer and due to its composition and microstructure an outstanding attachment to the TiCN layer. A good bonding between two layers is important in order to be able to apply high pressures during abrasion blasting without the layers spalling.

In a further embodiment of the invention a multi-layer PVD layer has an Al₂O₃ layer as outermost layer or an Al₂O₃ layer and above it a TiN or ZrN layer as outermost layers, wherein the layers have a higher hardness than the hardness of the abrasive. In a further preferred embodiment a TiAlN layer or several TiAlN layers are provided below the aluminium oxide layer. In the above-named embodiments the layer thickness of the Al₂O₃ layer lies in the range of from 0.5 μm to 10 μm, preferably of from 0.5 μm to 5 μm. The layer thicknesses of the nitride layers lie in the range of from 0.5 μm to 10 μm, preferably of from 0.5 μm to 5 μm. Instead of TiAlN layers, AlCrN layers or more complex metal nitride layers, such as carbonitride layers or boron carbonitride layers can also be used. More complex oxides, such as e.g. (AlCr)₂O₃, can also be used instead of aluminium oxide.

In a further preferred embodiment of the invention the TiCN layer has a layer thickness in the range of from 1 μm to 15 μm, preferably in the range of from 2 μm to 10 μm. The TiCN layer is expediently applied in the high-temperature CVD method or in the MT (medium-temperature) CVD method, wherein the MT-CVD method is preferred for the production of machining tools, as it delivers columnar layer structures and, because of the lower deposition temperature, reduces losses of toughness in the substrate. Layer sequences preferred according to the invention of the coating according to the invention are, starting from the substrate body:

### TiN—TiCN—TiAlCNO—Al₂O₃

### TiN-MT-TiCN—TiAlCNO—Al₂O₃—TiN.

TiN-MT-TiCN—TiAlCNO—(Al₂O₃/TiAlCNO)ₙ— MT-TiCN—TiN (n=1 to 5, preferably n=3)

A suitable total layer thickness lies in the range of from approximately 10 μm to 20 μm, wherein the TiCN layer and the Al₂O₃ layer each have a thickness of approximately 2 to 10 μm and the upper and lower TiN layers are each approximately 0.5 μm or thinner and the TiAlCNO layer (mixed phase of TiCN+aluminium titanate) has a thickness of approximately 0.5 μm to 1.5 μm.

The method according to the invention is characterized in that high residual compressive stresses are produced in the near-surface region of the substrate body. The abrasion blasting is expediently carried out such that a residual compressive stress of at least −500 MPa, more preferably of at least −1,000 MPa, more preferably of at least −1,500 MPa, more preferably of at least −2,000 MPa, is produced in the near-surface area of the substrate body. The residual compressive stress produced by the method according to the invention falls continuously to the inside of the substrate body, but residual compressive stresses which are higher than the residual compressive stresses produced according to the state of the art can be produced in the near-surface region of the substrate body by the method according to the invention.

With a system preferred according to the invention with a WC/Co hard-metal substrate body and a coating comprising 0.5 μm TiN, 10.0 μm MT-TiCN, 0.8 μm TiAlCNO, 9.0 μm (Al₂O₃/TiAlCNO)₃, 3.0 μm MT-TiCN and an outermost layer of 0.5 μm TiN (═HHT18, see below), residual compressive stresses of the order of up to −3,500 MPa and more can be produced in the outermost surface region of the substrate body by means of dry abrasion blasting with coarse-grained ZrO₂ as blasting abrasive for approximately 20 seconds and a blasting pressure in the range of approximately 4 bar.

The invention also expressly includes cutting inserts with the properties which can be produced in cutting inserts using the method according to the invention. The invention also includes cutting inserts which have been produced using the method according to the invention.

### Measurement Methods

The non-destructive and phase-selective analysis of residual stresses is possible only by X-ray diffraction methods (see for example V. Hauk. Structural and Residual Stress Analysis by Nondestructive Methods. Elsevier, Amsterdam, 1997). The widely-used angle-dispersive sin² ψ method (E. Macherauch, P. Müller, Z. angew. Physik 13 (1961), 305) for the X-ray analysis of residual stresses assumes an homogeneous stress condition within the penetration depth of the X-ray beam and delivers only a mean value for the stress portion in one plane. Therefore, the sin² ψ method is not suitable for investigating multi-layer, abrasion-blasted CVD systems in which steep or progressive changes in residual stress are expected within short distances. Instead of this, further-developed methods are applied which permit the recording of residual stress gradients even in thin layers (Ch. Genzel in: E. J. Mittemeijer, P. Scardi (Eds.) Diffraction Analysis of the Microstructure of Materials. Springer Series in Material Science, Volume 68 (2004), p. 473; Ch. Genzel, Mat. Science and Technol. 21 (2005), 10).

In order to analyze the depth profile of the residual stresses in the coating, the “universal plot method” (as described for example in H. Ruppersberg, I. Detemple, J. Krier, Phys. stat. sol. (a) 116 (1989), 681; Ch. Genzel, M. Broda, D. Dantz, W. Reimers, J. Appl. Cryst., 32 (1999), 779; Ch. Genzel, M. Klaus, I. Denks, H. G. WuIz, Mat. Sci. Eng. A390 (2005), 376,) was applied for the first time to abrasion-blasted multi-layer systems by the inventors. The method is based on a lattice strain depth-profile measurement up to very high tilt angles ψ, whereby the residual stress profiles of the layers are directly obtained. The residual stresses of the layers were carried out in the angle-dispersive diffraction mode on a GE Inspection Technologies (previously Seifert), 5-circle diffractometer ETA (Ch. Genzel, Adv. X-Ray Analysis, 44 (2001), 247.). The parameters used for measuring and determining the residual stresses are summarized in Table 1 below.

The non-destructive analysis of the residual stress distribution in the region of the boundary surface between the substrate body and the coating is possible only through high-energy X-ray diffraction using intensive parallel synchrotron radiation. In order to ascertain the influence of the blasting method on the state of the residual stress in the vicinity of the substrate surface, energy-dispersive diffraction was used for the first time. The “modified multi-wavelength method” (as described in C. Stock, doctoral thesis, TU Berlin, 2003; Ch. Genzel, C. Strock, W. Reimers, Mat. Sci. Eng., A 372 (2004), 28) was used which delivers the depth profile of the residual stresses in the substrate to a penetration depth dependent on the substrate material. With WC-Co substrates this penetration depth is approximately 10 μm. The experiments were carried out at the EDDI (Energy Dispersive Diffraction) Materials Research Measuring Station which is operated by the Hahn-Meitner-Institut Berlin on the BESSY synchrotron storage ring (Ch. Genzel, I. A. Denks, M. Klaus, Mat. Sci. Forum 524-525 (2006), 193). The corresponding experimental parameters are given in Table 2.

TABLE 1
Experimental parameters for the residual stress analysis of the coating

| | |
|---|---|
| Radiation | CuKα (without k_{β} filter) 40 kV/45 mA |
| | (long fine focus) |
| Diffraction mode | angle-dispersive |
| Optical elements | primary beam: polycapillary half-lens |
| | diffracted beam: parallel beam lens |
| | (0.4° Soller collimator + 001-LiF |
| | monochromator) |
| Reflections | Al₂O₃: 024 (2θ = 52.6°) |
| | TiCN: 422 (2θ = 123.5°) |
| ψ range | 0° . . . 89.5° (sin² ψ = 0 . . . 0.99996) |
| Measurement duration | 15 s/step in Δ2θ (0.05°) |
| Diffraction band evaluation | Pearson VII function for Kα₁ and Kα₂ bands |
| Linear absorption coefficients | μ_{Al2O3} = 124 cm⁻¹ |
| | μ_{TiCN} = 876 cm⁻¹ |
| Elastic diffraction constants | Al₂O₃: s₁ (024) = −0.55 × 10⁻⁶ MPa⁻¹ |
| (DEC)^{*)} | ½ s₂ (024) = 2.96 × 10⁻⁶ MPa⁻¹ |
| | TiCN: s₁ (422) = −0.474 × 10⁻⁶ MPa⁻¹ |
| | ½ s₂ (422) = 2.83 × 10⁻⁶ MPa⁻¹ |

^{*)}calculated using the monocrystal elasticity constants of Al₂O₃ (Landoldt-Börnstein, New Series, Group III, volume 11, Springer, Berlin, 1979) and TiN (W. Kress, P. Roedhammer, H. BiIz, W. Teuchert, A. N. Christensen. Phys. Rev. B17 (1978), 111.) according to the Eshelby-Kröner model (J. D. Eshelby. Proc. Roy. Soc. (London) A241 (1957), 376; E. Kröner, Z. Physik 151 (1958), 504.)

TABLE 2
Experimental parameters for the residual stress
analysis in the substrate bodies

| | |
|---|---|
| Radiation | white synchrotron radiation, |
| | E = [10 keV . . . 120 keV] |
| Diffraction mode | energy-dispersive |
| Beam cross-section | 0.25 × 0.25 mm² |
| Absorber | 2 cm graphite |
| Lens in the diffracted beam | double-slit system with an aperture of |
| | 0.03 × 5 mm² |
| Diffraction angle | 2θ = 9° |
| Detector | solid-state LEGe detector (Canberra) |
| Measurement mode | symmetrical ψ mode (reflection), |
| | ψ = 0° . . . 80°, Δψ = 2° |
| Measurement duration | 180 s/diffraction spectrum |
| Evaluated diffraction bands | 001, 101, 110, 002, 111 |
| Elastic diffraction constants | taken from B. Eigenmann, E. Macherauch, |
| | Mat.-Wiss. u. Werkstofftechn. |
| | 27 (1996), 426 |
| Calibration | with stress-free Au powder under the same |
| | experimental conditions |

### EXAMPLES

### Example 1

Using the methods according to the invention a WC/Co hard-metal substrate body (indexable inserts of the type SEHW1204AFN) was coated in the CVD method with multi-layer coatings and blasted with blasting abrasives of different hardness and particle size. Blasting time, particle size and pressure were varied.

The following coating systems were applied:

| | Layer sequence | | Total layer |
|---|---|---|---|
| Name | (starting from the substrate body) | | thickness |
| HHA10 | Substrate body | | 10 μm |
| | TiN | 0.5 μm | |
| | MT-TiCN | 4.0 μm | |
| | TiAlCNO | 1.0 μm | |
| | Al₂O₃ | 4.0 μm | |
| | TiN | 0.5 μm | |
| HHA17 | Substrate body | | 17 μm |
| | TiN | 0.5 μm | |
| | MT-TiCN | 10.0 μm | |
| | TiAlCNO | 1.0 μm | |
| | Al₂O₃ | 5.0 μm | |
| | TiN | 0.5 μm | |
| HHT18 | Substrate body | | 18 μm |
| | TiN | 0.5 μm | |
| | MT-TiCN | 5.0 μm | |
| | TiAlCNO | 0.8 μm | |
| | (Al₂O₃/TiAlCNO)₃ | 8.4 μm (2.0 μm/0.8 μm) | |
| | MT-TiCN | 3.0 μm | |
| | TiN | 0.5 μm | |

The coated substrate bodies were subjected to dry blasting with different blasting abrasives (steel, glass or ZrO₂) the hardnesses of which are lower than the hardnesses of the outermost TiN layer at a jet angle of 90° and a blasting distance (=distance from the nozzle to the tool surface) of 60 mm. Only the machined surface of the body was blasted. The residual stresses in the outermost Al₂O₃ layer, the MT-TiCN layer and in the near interface substrate zone of the substrate body were then measured at the machined surface according to the previously described methods. The conditions of the abrasion blasting and the results of the residual stress measurements are given in Table 3. Positive values denote residual tensile stresses, negative values denote residual compressive stresses.

For the purposes of comparison, the hard-metal substrate body with the WAA coating was treated with corundum (Al₂O₃) as blasting abrasive the hardness of which is higher than the hardness of the TiN layer and which therefore had an abrasive effect as far as the abrasion of the TiN layer.

TABLE 3

| | | | Blasting | | | | Substrate | | | |
|---|---|---|---|---|---|---|---|---|---|---|
| Coating | Outermost | Blasting | pressure/ | TiCN | Al2O3 | TiCN | WC | | | ΔS_{BES}/ |
| system | layer | abrasive | blasting time | [MPa] | [MPa] | [MPa] | [MPa] | ΔS_{BES} | ΔS_{SUB} | ΔS_{SUB} |
| HHA10 | TiN | non- | | — | 264 | 323 | −450 | — | — | — |
| | | blasted | | | | | | | | |
| HHA17 | TiN | non- | | — | 256 | 330 | −490 | — | — | — |
| | | blasted | | | | | | | | |
| HHA18 | TiN | non- | | 142 | 361 | 466 | −395 | — | — | — |
| | | blasted | | | | | | | | |
| HHA17 | Al2O3 | Al2O3 | 4 bar/10 sec | — | −4200 | 357 | −460 | 4456 | 30 | 148 |
| HHA10 | Al2O3 | Al2O3 | 4 bar/20 sec | — | −4816 | 129 | −663 | 5080 | 213 | 23.85 |
| HHA10 | Al2O3 | Al2O3 | 2 bar/20 sec | — | −2819 | 312 | −639 | 3083 | 189 | 16.31 |
| HHA10 | TiN | glass | 2 bar/20 sec | — | 92 | 391 | −667 | 172 | 217 | 0.793 |
| | | (fine) | | | | | | | | |
| HHA10 | TiN | glass | 4 bar/20 sec | — | −447 | 286 | −1190 | 711 | 740 | 0.961 |
| | | (fine) | | | | | | | | |
| HHA10 | TiN | glass | 2 bar/20 sec | — | 205 | 280 | −1045 | 59 | 595 | 0.099 |
| | | (coarse) | | | | | | | | |
| HHA10 | TiN | glass | 4 bar/20 sec | — | 40 | 192 | −1046 | 224 | 596 | 0.376 |
| | | (coarse) | | | | | | | | |
| HHA10 | TiN | glass | 4 bar/100 sec | — | 50 | 222 | −790 | 214 | 340 | 0.629 |
| | | (coarse) | | | | | | | | |
| HHA10 | TiN | steel | 2 bar/20 sec | — | 169 | 249 | −780 | 95 | 330 | 0.288 |
| HHA10 | TiN | steel | 4 bar/30 sec | — | 187 | 547 | −720 | 224 | 270 | 0.830 |
| HHA10 | TiN | steel | 4 bar/360 sec | — | 35 | 598 | −600 | 275 | 150 | 1.833 |
| HHA10 | TiN | ZrO2 | 2 bar/20 sec | — | 117 | 290 | −1116 | 147 | 666 | 0.221 |
| | | (fine) | | | | | | | | |
| HHA10 | TiN | ZrO2 | 2 bar/120 sec | — | 188 | 400 | −1200 | 77 | 750 | 0.103 |
| | | (fine) | | | | | | | | |
| HHA10 | TiN | ZrO2 | 4 bar/20 sec | — | 71 | 371 | −1585 | 193 | 1135 | 0.170 |
| | | (fine) | | | | | | | | |
| HHA10 | TiN | ZrO2 | 2 bar/20 sec | — | 98 | 217 | −1591 | 166 | 1141 | 0.145 |
| | | (coarse) | | | | | | | | |
| HHA10 | TiN | ZrO2 | 2 bar/120 sec | — | 115 | 510 | −1100 | 187 | 650 | 0.288 |
| | | (coarse) | | | | | | | | |
| HHA10 | TiN | ZrO2 | 4 bar/20 sec | — | −260 | 167 | −1296 | 524 | 846 | 0.619 |
| | | (coarse) | | | | | | | | |
| HHA17 | TiN | steel | 2 bar/30 sec | — | 262 | 679 | −985 | 349 | 495 | 0.705 |
| HHA17 | TiN | steel | 2 bar/360 sec | — | 227 | 684 | −610 | 354 | 180 | 1.967 |
| HHA17 | TiN | steel | 4 bar/30 sec | — | 126 | 666 | −723 | 336 | 233 | 1.442 |
| HHA17 | TiN | steel | 4 bar/360 sec | — | 162 | 697 | −1000 | 367 | 510 | 0.720 |
| HHA17 | TiN | glass | 2 bar/90 sec | — | −76 | 777 | −877 | 447 | 387 | 1.150 |
| HHA17 | TiN | ZrO2 | 2 bar/30 sec | — | 208 | 581 | −1050 | 251 | 560 | 0.448 |
| | | (coarse) | | | | | | | | |
| HHA17 | TiN | ZrO2 | 4 bar/120 sec | — | 193 | 764 | −1020 | 434 | 530 | 0.818 |
| | | (coarse) | | | | | | | | |
| HHA17 | TiN | ZrO2 | 4 bar/360 sec | — | 89 | 592 | −1300 | 262 | 810 | 0.323 |
| | | (coarse) | | | | | | | | |
| HHA17 | TiN | ZrO2 | 4 bar/30 sec | — | 277 | 235 | −900 | 95 | 410 | 0.231 |
| | | (fine) | | | | | | | | |
| HHA17 | TiN | ZrO2 | 4 bar/60 sec | — | 189 | 543 | −942 | 213 | 452 | 0.471 |
| | | (fine) | | | | | | | | |
| HHA17 | TiN | ZrO2 | 4 bar/300 sec | — | 123 | 507 | −1200 | 177 | 710 | 0.249 |
| | | (fine) | | | | | | | | |
| HHT18 | TiN | glass | 4 bar/72 sec | −772 | 268 | 602 | −1356 | 1228 | 961 | 1.278 |
| | | (fine) | | | | | | | | |
| HHT18 | TiN | ZrO2 | 4 bar/150 sec | −640 | 231 | 602 | −1355 | 1106 | 960 | 1.152 |
| | | (fine) | | | | | | | | |
| HHT18 | TiN | ZrO2 | 4 bar/390 sec | −361 | 272 | 602 | −3851 | 827 | 3456 | 0.239 |
| | | (coarse) | | | | | | | | |

*) positive values signify residual tensile stresses, negative values signify residual compressive stresses.

### Example 2

Cutting inserts of the type SEHW1204AFN with the same substrate body and the coating HHA 17 were subjected to different abrasion blastings according to the invention and then the strip rotation test (test with disrupted section) on a 42CrMo4 workpiece (v_{c}=250 m/min, f=0.32 mm, Rm=1000 N/mm², aₚ=2.5 mm). For comparison a non-blasted cutting insert and one wet-blasted according to the state of the art with Al₂O₃ were examined.

The results are reproduced in Table 4 below. The impact count values are mean values from 5 strip rotation tests each with samples treated identically.

TABLE 4

| | Blasting | Life (impact |
|---|---|---|
| | pressure/ | count-mean value |
| Blasting abrasive | blasting time | from five tests) |
| non-blasted | — | 275 |
| Al2O3 (wet) | 4 bar/10 sec | 855 |
| (=state of the art) | | |
| ZrO2 (350B) | 4 bar/120 sec | 3253 |
| ZrO2 (120B) | 2 bar/120 sec | 3060 |
| ZrO2 (120B) | 2 bar/30 sec | 2108 |
| Steel (SDK0, 2B) | 4 bar/360 sec | 2268 |
| Glass (MS100B) | 2 bar/90 sec | 1786 |

The higher the toughness of a tool, the better (higher) the value of the impact rate in the strip rotation test. From the results of the strip rotation tests it is clear what outstanding gains in toughness are achieved by the method according to the invention in otherwise identical tools compared with non-blasted tools. Also, substantially better results are achieved compared with the use of an abrasive according to the state of the art. The life of the cutting edges was higher by a factor of 2 to 4 than in tools which were wet-blasted with Al₂O₃ according to the state of the art.

1. Method for the production of a cutting insert, in which a hard-metal, cermet, or ceramic substrate body is coated by means of a PVD, PCVD or CVD method with a single- or multi-layer coating of carbides, nitrides, oxides, carbonitrides, oxinitrides, oxicarbides, oxicarbonitrides, borides, boron nitrides, boron carbides, boron carbonitrides, boron oxinitrides, boron oxocarbides, boron oxocarbonitrides of the elements of groups IVa to VIIa of the periodic table and/or of aluminium and/or mixed-metal phases and/or phase mixtures of the above-named compounds and, after the coating, the substrate body is subjected to dry or wet abrasion blasting using a granular blasting abrasive, wherein
the hardness of the abrasive is lower than the hardness of the outermost layer of the coating or
the hardness of the abrasive is higher than the hardness of the outermost layer of the coating and, below the outermost layer, a layer is arranged the hardness of which is higher than the hardness of the abrasive, wherein at least portions of the layer(s) arranged above the layer the hardness of which is higher than the hardness of the abrasive are abraded by the abrasion blasting,
the total layer thickness of the coating is at most 40 μm,
the abrasion blasting takes place at a blasting pressure of 1 bar to 10 bar and is carried out for a period which is sufficient for
10 MPa<ΔS_{BES}<1000 MPa and
[ΔS_{BES}/ΔS_{SUB}]<2,
wherein Δ S_{BES} is the value of the greatest change in residual stress in the coating after abrasion blasting compared with the non-abrasion-blasted cutting insert and Δ S_{SUB} is the value of the greatest change in residual stress in the substrate after abrasion blasting compared with the non-abrasion-blasted cutting insert in an area of the substrate surface to a penetration depth of 10 μm.

2. Method according to claim 1, wherein the total layer thickness of the coating is at most 30 μm.

3. Method according to claim 1, wherein the total layer thickness of the coating is at least 1 μm.

4. Method according to claim 1, wherein the abrasion blasting is carried out over a period of at least 5 seconds.

5. Method according to claim 1, wherein the abrasion blasting is carried out at a blasting pressure of 2 bar to 8 bar.

6. Method according to claim 1, wherein the abrasion blasting is dry abrasion blasting.

7. Method according to claim 1, wherein the layer furthermost from the substrate, the hardness of which is higher than the hardness of the abrasive, is a TiN layer, an Al₂O₃ layer or a TiAlN layer.

8. Method according to claim 1, wherein the abrasive consists of steel, glass or ZrO₂.

9. Method according to claim 1, wherein a TiCN layer and/or a TiAlCNO layer is/are arranged below the layer the hardness of which is higher than the hardness of the abrasive, wherein further layers may be arranged above and/or below the TiCN layer and/or the TiAlCNO layer.

10. Method according to claim 9, wherein the TiCN layer and/or the TiAlCNO layer each has a layer thickness in the range of from 1 μm to 5 μm.

11. Method according to claim 1, wherein a residual compressive stress of at least −500 MPa is produced by the abrasion blasting in the substrate body in the outermost surface region.

12. Method according to claim 1, wherein residual compressive stress of at least −250 MPa is produced by the abrasion blasting on the inside of the substrate body at a depth of 3 to 4 μm from the outermost surface of the substrate body.

13. Method according to claim 1, wherein the residual compressive stress produced in the substrate body by the abrasion blasting at a depth of 5 μm inside the substrate body is, according to the amount, lower by at least 250 MPa than at the outermost surface of the substrate body.

14. Method according to claim 1, wherein the hardness of the abrasive is higher than the hardness of the outermost layer of the coating and a layer the hardness of which is higher than the hardness of the abrasive is arranged below the outermost layer, wherein the layer(s) arranged above the layer the hardness of which is equal to the hardness of the abrasive is (are) abraded by the abrasion blasting only from the machined surface or from the side of the cutting insert comprising the machined surface.

15. Cutting insert which can be produced using a method according to claim 1.

16. Method according to claim 11, wherein the residual compressive stress is at least −2,000 MPa.

17. Method according to claim 12, wherein the residual compressive stress is at least −750 MPa.

18. Method according to claim 13, wherein the residual compressive stress is lower by at least 750 MPa.

19. Method according to claim 2, wherein the total layer thickness of the coating is at most 20 μm.

20. Method according to claim 3, wherein the total layer thickness of the coating is at least 10 μm.
